(19) United States
(12) Patent Application Publication
(10) Pub. No.: US 2014/0337021 A1
(43) Pub. Date: Nov. 13, 2014

(54) SYSTEMS AND METHODS FOR NOISE CHARACTERISTIC DEPENDENT SPEECH ENHANCEMENT

(71) Applicant: QUALCOMM Incorporated, San Diego, CA (US)

(72) Inventors: Lae-Hoon Kim, San Diego, CA (US); Juhan Nam, San Diego, CA (US); Erik Visser, San Diego, CA (US)

(73) Assignee: QUALCOMM Incorporated, San Diego, CA (US)

(21) Appl. No.: 14/083,183

(22) Filed: Nov. 18, 2013

Related U.S. Application Data
(60) Provisional application No. 61/821,821, filed on May 10, 2013.

(51) Int. Cl. G10L 21/0208

(52) U.S. Cl. CPC G10L 21/0208
USPC 704/228

(57) ABSTRACT

A method for noise characteristic dependent speech enhancement by an electronic device is described. The method includes determining a noise characteristic of input audio. Determining a noise characteristic of input audio includes determining whether noise is stationary noise and determining whether the noise is music noise. The method also includes determining a noise reference based on the noise characteristic. Determining the noise reference includes excluding a spatial noise reference from the noise reference when the noise is stationary noise and including the spatial noise reference in the noise reference when the noise is not music noise and is not stationary noise. The method further includes performing noise suppression based on the noise characteristic.

### RELATED APPLICATIONS

This application is related to and claims priority to U.S. Provisional Patent Application Ser. No. 61/821,821 filed May 10, 2013, for “NOISE CHARACTERISTIC DEPENDENT SPEECH ENHANCEMENT.”

### TECHNICAL FIELD

The present disclosure relates generally to electronic devices. More specifically, the present disclosure relates to systems and methods for noise characteristic dependent speech enhancement.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or with higher quality are often sought after.

Some electronic devices (e.g., cellular phones, smartphones, audio recorders, camcorders, computers, etc.) utilize audio signals. These electronic devices may encode, store and/or transmit the audio signals. For example, a smartphone may obtain, encode and transmit a speech signal for a phone call, while another smartphone may receive and decode the speech signal.

However, particular challenges arise in obtaining a clear speech signal in noisy environments. For example, a variety of background noises may corrupt an audio signal and render speech difficult to hear or understand. As can be observed from this discussion, systems and methods that improve speech signal quality may be beneficial.

### SUMMARY

A method for noise characteristic dependent speech enhancement by an electronic device is described. The method includes determining a noise characteristic of input audio. Determining a noise characteristic includes determining whether noise is stationary noise and determining whether the noise is music noise. The method also includes determining a noise reference based on the noise characteristic. Determining a noise reference includes excluding a spatial noise reference from the noise reference when the noise is stationary noise and including the spatial noise reference in the noise reference when the noise is not music noise and is not stationary noise. The method further includes performing noise suppression based on the noise characteristic. Determining the noise reference may include including the spatial noise reference and including a music noise reference in the noise reference when the noise is music noise and is not stationary noise.

Determining the noise characteristic may include detecting rhythmic noise, sustained polyphonic noise or both. Detecting rhythmic noise may include determining an onset of a beat based on a spectrogram and providing spectral features. Determining the noise reference may include determining a rhythmic noise reference when the beat is detected regularly.

Detecting sustained polyphonic noise may include mapping a spectrogram to a group of subbands with center frequencies that are logarithmically scaled, detecting stationarity based on an energy ratio between a high-pass filter output and input for each subband and tracking stationarity for each subband. Determining the noise reference may include determining a sustained polyphonic noise reference based on the tracking.

The spatial noise reference may be determined based on directionality of the input audio. The spatial noise reference may be determined based on a level offset.

An electronic device for noise characteristic dependent speech enhancement is also included. The electronic device includes noise characteristic determiner circuitry that determines a noise characteristic of input audio. Determining the noise characteristic includes determining whether noise is stationary noise and determining whether the noise is music noise. The electronic device also includes noise reference determiner circuitry coupled to the noise characteristic determiner circuitry. The noise reference determiner circuitry determines a noise reference based on the noise characteristic. Determining the noise reference includes excluding a spatial noise reference from the noise reference when the noise is stationary noise and including the spatial noise reference in the noise reference when the noise is not music noise and is not stationary noise. The electronic device further includes noise suppressor circuitry coupled to the noise characteristic determiner circuitry and to the noise reference determiner circuitry. The noise suppressor circuitry performs noise suppression based on the noise characteristic.

A computer-program product for noise characteristic dependent speech enhancement is also described. The computer-program product includes a non-transitory tangible computer-readable medium with instructions. The instructions include code for causing an electronic device to determine a noise characteristic of input audio. Determining a noise characteristic includes determining whether noise is stationary noise and determining whether the noise is music noise. The instructions also include code for causing the electronic device to determine a noise reference based on the noise characteristic. Determining a noise reference includes excluding a spatial noise reference from the noise reference when the noise is stationary noise and including the spatial noise reference in the noise reference when the noise is not music noise and is not stationary noise. The instructions further include code for causing the electronic device to perform noise suppression based on the noise characteristic.

An apparatus for noise characteristic dependent speech enhancement by an electronic device is also described. The apparatus includes means for determining a noise characteristic of input audio. The means for determining a noise characteristic includes means for determining whether noise is stationary noise and means for determining whether the noise is music noise. The apparatus also includes means for determining a noise reference based on the noise characteristic. Determining a noise reference includes excluding a spatial noise reference from the noise reference when the noise is stationary noise and including the spatial noise reference in the noise reference when the noise is not music noise and is not stationary noise. The apparatus further includes means for performing noise suppression based on the noise characteristic.

### BRIEF DESCRIPTION OF THE DRAWINGS

FIG. 1 is a block diagram illustrating one configuration of an electronic device in which systems and methods for noise characteristic dependent speech enhancement may be implemented;

FIG. 2 is a flow diagram illustrating one configuration of a method for noise characteristic dependent speech enhancement;

FIG. 3 is a block diagram illustrating one configuration of a music noise detector;

FIG. 4 is a block diagram illustrating one configuration of a beat detector and a music noise reference generator;

FIG. 5 is a block diagram illustrating one configuration of a sustained polyphonic noise detector and a music noise reference generator;

FIG. 6 is a block diagram illustrating one configuration of a stationary noise detector;

FIG. 7 is a block diagram illustrating one configuration of a spatial noise reference generator;

FIG. 8 is a block diagram illustrating another configuration of a spatial noise reference generator;

FIG. 9 is a flow diagram illustrating one configuration of a method for noise characteristic dependent speech enhancement; and

FIG. 10 illustrates various components that may be utilized in an electronic device.

### DETAILED DESCRIPTION

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

In known approaches, noise suppression algorithms may apply the same procedure regardless of noise characteristics (e.g., timbre and/or spatiality). If a noise reference reflects the amount of noise with the different nature properly, this approach may work relatively well. However, often there is some unnecessary back and forth in noise suppression tuning due to the differing nature of background noise. Also, sometimes it is difficult to find the proper solution for a certain noise scenario due to the fact that a universal solution for all different noise cases is desired.

Known approaches may not offer discrimination in the noise reference. Accordingly, it may be difficult to achieve required noise suppression without degrading performance in other noisy speech scenarios with a different kind of noise. For example, it may be difficult to achieve good performance in single/multiple microphone cases with highly non-stationary noise (e.g., music noise) versus stationary noise. One typical problematic scenario occurs when using dual microphones for a device in portrait (e.g., “browse-talk”) mode with a top-down microphone configuration. This scenario becomes essentially the same as a single microphone configuration in terms of direction-of-arrival (DOA), since the DOA of target speech and noise may be the same or very similar. Current dual-microphone noise suppression may not be sufficient due to the lack of a non-stationary noise reference based on DOA difference. However, if a noise characteristic (or type) is detected, noise references may be determined based on the noise characteristic (or type). For example, a music noise reference may be generated based on rhythmic structure and/or polyphonic source sustainment. Additionally or alternatively, a non-stationary noise reference may be generated based on statistics of distribution of spectrum over time.

Before applying noise suppression, the present systems and methods may determine a noise characteristic (e.g., perform noise type detection) and apply a noise suppression scheme tailored to the noise characteristic. In particular, the systems and methods disclosed herein provide approaches for noise characteristic dependent speech enhancement.

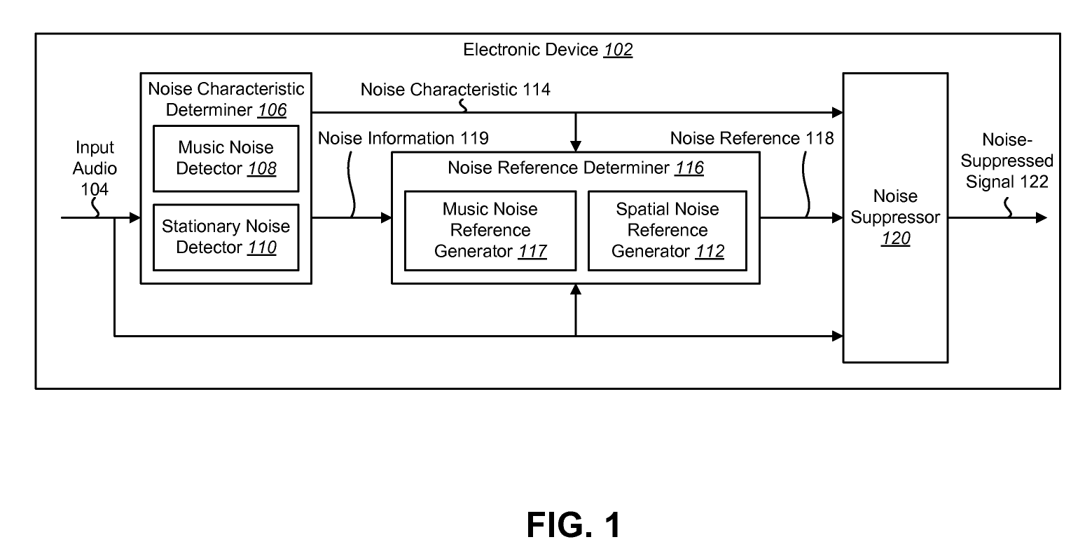

FIG. 1 is a block diagram illustrating one configuration of an electronic device 102 in which systems and methods for noise characteristic dependent speech enhancement may be implemented. Examples of the electronic device 102 include cellular phones, smartphones, tablet devices, personal digital assistants (PDAs), audio recorders, camcorders, still cameras, laptop computers, wireless modems, other mobile electronic devices, telephones, speaker phones, personal computers, televisions, game consoles and other electronic devices. An electronic device 102 may alternatively be referred to as an access terminal, a mobile terminal, a mobile station, a remote station, a user terminal, a terminal, a subscriber unit, a subscriber station, a mobile device, a wireless device, a wireless communication device, user equipment (UE) or some other similar terminology. The electronic device 102 may include a noise characteristic determiner 106, a noise reference determiner 116 and/or a noise suppressor 120. One or more of the elements included in the electronic device 102 may be implemented in hardware (e.g., circuitry) or a combination of hardware and software. It should be noted that the term “circuitry” may mean one or more circuits and/or circuit components. For example, “circuitry” may be one or more circuits or may be a component of a circuit. Arrows and/or lines illustrated in the block diagrams in the Figures may represent direct or indirect couplings between the elements described.

The electronic device 102 may obtain input audio 104. For example, the electronic device 102 may obtain the input audio 104 from one or more microphones integrated into the electronic device 102 or may receive the input audio 104 from another device (e.g., a Bluetooth headset). For example, a “capturing device” may be a device that captures the input audio 104 (e.g., the electronic device 102 or another device that provides the input audio 104 to the electronic device 102). The input audio 104 may include one or more electronic audio signals. In some configurations, the input audio 104 may be a multi-channel electronic audio signal captured from multiple microphones. For example, the electronic device 102 may include N microphones that receive sound input from one or more sources (e.g., one or more users, a speaker, background noise, echo/echoes from a speaker/speakers (stereo/surround sound), musical instruments, etc.). Each of the N microphones may produce a separate signal or channel of audio that may be slightly different than one another. In one configuration, the electronic device 102 may include two microphones that produce two channels of input audio 104. In other configurations, other numbers of microphones may be used. In some scenarios, one of the microphones may be closer to a user's mouth than one or more other microphones. In these scenarios, the term “primary microphone” may refer to a microphone closest to a user's mouth. All non-primary microphones may be considered secondary microphones. It should be noted that the microphone that is the primary microphone may change over time as the location and orientation of the capturing device may change. Although not shown in FIG. 1, the electronic device 102 may include additional elements or modules to process acoustic signals into digital audio and vice versa.

In some configurations, the input audio 104 may be divided into frames. A frame of the input audio 104 may include a particular time period of the input audio 104 and/or a particular number of samples of the input audio 104.

The input audio 104 may include target speech and/or interfering (e.g., undesired) sounds. For example, the target speech in the input audio 104 may include speech from one or more users. The interfering sounds in the input audio 104 may be referred to as noise. For example, noise may be any sound that interferes with or obscures the target speech (by masking the target speech, by reducing the intelligibility of the target speech, by overpowering the target speech, etc., for example). Different kinds of noise may occur in the input audio 104. For example, noise may be classified as stationary noise, non-stationary noise and/or music noise. Examples of stationary noise include white noise (e.g., noise with an approximately flat power spectral density over a spectral range and over a time period) and pink noise (e.g. noise with a power spectral density that is approximately inversely proportional to frequency over a frequency range and over a time period). Examples of non-stationary noise include interfering talkers and noises with significant variance in frequency and in time. Examples of music noise include instrumental music (e.g., sounds produced by musical instruments such as string instruments, percussion instruments, wind instruments, etc.).

The input audio 104 (e.g., one or more channels of electronic audio signals) may be provided to the noise characteristic determiner 106, to the noise reference determiner 116 and/or to the noise suppressor 120. The noise characteristic determiner 106 may determine a noise characteristic 114 based on the input audio 104. For example, the noise characteristic determiner 106 may determine whether noise in the input audio 104 is stationary noise, non-stationary noise and/or music noise. The noise characteristic determiner 106 and/or one or more of the elements of the noise characteristic determiner 106 may utilize one or more channels of the input audio 104 for determining the noise characteristic 114 and/or for detecting noise.

In some configurations, the noise characteristic determiner 106 may include a music noise detector 108 and/or a stationary noise detector 110. The stationary noise detector 110 may detect whether noise in the input audio 104 is stationary noise. Stationary noise detection may be based on one or more channels of the input audio 104. In some configurations, the stationary noise detector 110 may measure the spectral flatness of each frame of one or more channels of the input audio 104. Frames that meet at least one spectral flatness criterion may be detected (e.g., declared, designated, etc.) as including stationary noise. The stationary noise detector 110 may count frames that are detected as including stationary noise (within a stationary noise detection time interval, for example). The stationary noise detector 110 may determine whether the noise in the input audio 104 is stationary noise based on whether enough frames in the stationary noise detection time interval are detected as including stationary noise. For example, if the number of frames detected as including stationary noise within the stationary noise detection time interval is greater than a stationary noise detection threshold, the stationary noise detector 110 may indicate that the noise in the input audio 104 is stationary noise.

The music noise detector 108 may detect whether noise in the input audio 104 is music noise. Music noise detection may be based on one or more channels of the input audio 104. One or more approaches may be utilized to detect music noise. One approach may include detecting rhythmic noise (e.g., drum noise). Rhythmic noise may include one or more regularly recurring sounds that interfere with target speech. For example, music may include “beats,” which may be sounds that provide a rhythmic effect. Beats are often produced by one or more percussive instruments (or synthesized versions and/or reproduced versions thereof) such as bass drums (e.g., “kick” drums), snare drums, cymbals (e.g., hi-hats, ride cymbals, etc.), cowbells, woodblocks, hand claps, etc.

In some configurations, the music noise detector 108 may include a beat detector (e.g., drum detector). For example, the beat detector may determine a spectrogram of the input audio 104. A spectrogram may represent the input audio 104 based on time, frequency and amplitude (e.g., power) components of the input audio 104. It should be noted that the spectrogram may or may not be represented in a visual format. The beat detector may utilize the spectrogram (e.g., extracted spectrogram features) to perform onset detection using spectral gravity (e.g., spectral centroid or roll-off) and energy fluctuation in each frame. When a beat onset is detected, the spectrogram features may be tracked over one or more subsequent frames to ensure that a beat event is occurring.

The music noise detector 108 may count a number of frames with a detected beat within a beat detection time interval. The music noise detector 108 may also count a number of frames in between detected beats. The music noise detector 108 may utilize the number of frames with a detected beat within the beat detection time interval and the number of frames in between detected beats to determine (e.g., detect) whether a regular rhythmic structure is occurring in the input audio 104. The presence of a regular rhythmic structure in the input audio 104 may indicate that rhythmic noise is present in the input audio 104. The music noise detector 108 may detect music noise in the input audio 104 based on whether rhythmic noise or a regular rhythmic structure is occurring in the input audio 104.

Another approach to detecting music noise may include detecting sustained polyphonic noise. Sustained polyphonic noise includes one or more tones (e.g., notes) sustained over a period of time that interfere with target speech. For example, music may include sustained instrumental tones. For instance, sustained polyphonic noise may include sounds from string instruments, wind instruments and/or other instruments (e.g., violins, guitars, flutes, clarinets, trumpets, tubas, pianos, synthesizers, etc.).

In some configurations, the music noise detector 108 may include a sustained polyphonic noise detector. For example, the sustained polyphonic noise detector may determine a spectrogram (e.g., power spectrogram) of the input audio 104. The sustained polyphonic noise detector may map the spectrogram (e.g., spectrogram power) to a group of subbands. The group of subbands may have uniform or non-uniform spectral widths. For example, the subbands may be distributed in accordance with a perceptual scale and/or have center frequencies that are logarithmically scaled (according to the Bark scale, for instance). This may reduce the number of subbands, which may improve computation efficiency.

Frequency and amplitude tend to vary significantly in a typical speech signal. In music, however, some instrumental sounds tend to exhibit strong stationarity in one or more subbands. Accordingly, the sustained polyphonic noise detector may determine whether the energy in each subband is stationary. For example, stationarity may be detected based on an energy ratio between a high-pass filter output and input (e.g., input audio 104). The music noise detector 108 may track stationarity for each subband. The stationarity may be tracked to determine whether subband energy is sustained for a period of time (e.g., a threshold period of time, a number of frames, etc.). The music noise detector 108 may detect sustained polyphonic noise if the subband energy is sustained for at least the period of time. The music noise detector 108 may detect music noise in the input audio 104 based on whether sustained polyphonic noise is occurring in the input audio 104.

In some configurations, the music noise detector 108 may detect music noise based on a combination of detecting rhythmic noise and detecting sustained polyphonic noise. In one example, the music noise detector 108 may detect music noise if both rhythmic noise and sustained polyphonic noise are detected. In another example, the music noise detector 108 may detect music noise if rhythmic noise or sustained polyphonic noise is detected. In yet another example, the music noise detector 108 may detect music noise based on a linear combination of detecting rhythmic noise and detecting sustained polyphonic noise. For instance, rhythmic noise may be detected at varying degrees (of strength or probability, for example) and sustained polyphonic noise may be detected at varying degrees (of strength or probability, for example). The music noise detector 108 may combine the degree of rhythmic noise and the degree of sustained polyphonic noise in order to determine whether music noise is detected. In some configurations, the degree of rhythmic noise and/or the degree of sustained polyphonic noise may be weighted in determining whether music noise is detected.

The noise characteristic determiner 106 may determine the noise characteristic 114 based on whether stationary noise and/or music noise is detected. The noise characteristic 114 may be a signal or indicator that indicates whether the noise in the input audio 104 (e.g., input audio signal) is stationary noise, non-stationary noise and/or music noise. For example, if the stationary noise detector 110 detects stationary noise, the noise characteristic determiner 106 may produce a noise characteristic 114 that indicates stationary noise. If the stationary noise detector 110 does not detect stationary noise and the music noise detector 108 does not detect music noise, the noise characteristic determiner 106 may produce a noise characteristic 114 that indicates non-stationary noise. If the stationary noise detector 110 does not detect stationary noise and the music noise detector 108 detects music noise, the noise characteristic determiner 106 may produce a noise characteristic 114 that indicates music noise. The noise characteristic 114 may be provided to the noise reference determiner 116 and/or to the noise suppressor 120.

The noise reference determiner 116 may determine a noise reference 118. Determining the noise reference 118 may be based on the noise characteristic 114, the noise information 119 and/or the input audio 104. The noise reference 118 may be a signal or indicator that indicates the noise to be suppressed in the input audio 104. For example, the noise reference 118 may be utilized by the noise suppressor 120 (e.g., a Wiener filter) to suppress noise in the input audio 104. For instance, the electronic device 102 (e.g., noise suppressor 120) may determine a signal-to-noise ratio (SNR) based on the noise reference 118, which may be utilized in the noise suppression. It should be noted that the noise reference determiner 116 or one or more elements thereof may be implemented as part of the noise characteristic determiner 106, implemented as part of the noise suppressor or implemented separately.

In some configurations, a noise reference 118 is a magnitude response in the frequency domain representing a noise signal in the input signal (e.g., input audio 104). Much of the noise suppression (e.g., noise suppression algorithm) described herein may be based on estimation of SNR, where if SNR is higher, the suppression gain becomes nearer to the unity and vice versa (e.g., if SNR is lower, the suppression gain may be lower). Accordingly, accurate estimation of the noise-only part (e.g., noise signal) may be beneficial.

In some configurations, the noise reference determiner 116 may generate a stationary noise reference based on the input audio 104, the noise information 119 and/or the noise characteristic 114. For example, when the noise characteristic 114 indicates stationary noise, the noise reference determiner 116 may generate a stationary noise reference. In this case, the stationary noise reference may be included in the noise reference 118 that is provided to the noise suppressor 120. The characteristics of stationary noise are approximately time-invariant. In the case of stationary noise, smoothing in time may be applied to penalize on accidentally capturing target speech. The stationary noise case may be relatively easier to handle than the non-stationary noise case.

Non-stationary noise may be estimated without smoothing (or with a small amount of smoothing) to capture the non-stationarity effectively. In this context, a spatially processed noise reference may be used, where the target speech is nulled out as much as possible. However, it should be noted that the non-stationary noise estimate using spatial processing is more effective when the directions of arrival for target speech and noise are different. For music noise, it may be beneficial to estimate the noise reference without the spatial discrimination based on music-specific characteristics (e.g., sustained harmonicity and/or a regular rhythmic pattern). Once those characteristics are identified, it may be attempted to locate the corresponding relevant region(s) in time-frequency domain. Those characteristics and/or regions may be included in the noise reference estimation, in order to suppress such region(s) (even without spatial discrimination, for example).

In some configurations, the noise reference determiner 116 may include a music noise reference generator 117 and/or a spatial noise reference generator 112. In some configurations, the music noise reference generator 117 may include a rhythmic noise reference generator and/or a sustained polyphonic noise reference generator. The music noise reference generator 117 may generate a music noise reference. The music noise reference may include a rhythmic noise reference (e.g., beat noise reference, drum noise reference) and/or a sustained polyphonic noise reference.

In some configurations, the noise characteristic determiner 106 may provide noise information 119 to the noise reference determiner 116. The noise information 119 may include information related to processing performed by the noise characteristic determiner 106. For example, the noise information 119 may indicate whether a beat (e.g., beat noise) is being detected, may indicate whether sustained polyphonic noise is being detected, may include one or more spectrograms and/or may include one or more features of noise detected by the music noise detector 108.

In some configurations, the music noise reference generator 117 may generate a rhythmic noise reference. The music noise detector 108 may provide a beat indicator, a spectrogram and/or one or more extracted features to the music noise reference generator 117 in the noise information 119.

The music noise reference generator 117 may utilize the beat detection indicator, the spectrogram and/or the one or more extracted features to generate the rhythmic noise reference. In some configurations, the beat detection indicator may activate rhythmic noise reference generation. For example, the music noise detector 108 may provide a beat indicator indicating that a beat is occurring in the input audio 104 when a beat is detected regularly (e.g., over some period of time). Accordingly, rhythmic noise reference generation may be activated when a beat is detected regularly.

When rhythmic noise reference generation is active, the music noise reference generator 117 may utilize the extracted features and/or the spectrogram to generate the rhythmic noise reference. The extracted features may be signal information corresponding to the rhythmic noise. For example, the extracted features may include temporal and/or spectral information corresponding to the rhythmic noise. For instance, the extracted features may be a frequency-domain signal and/or a time-domain signal of a bass drum extracted from the input audio 104.

In some configurations, the music noise reference generator 117 may generate a polyphonic noise reference. The music noise detector 108 may provide a sustained polyphonic noise indicator, a spectrogram and/or one or more extracted features to the music noise reference generator 117 in the noise information 119.

The music noise reference generator 117 may utilize the sustained polyphonic noise indicator, the spectrogram and/or the one or more extracted features to generate the sustained polyphonic noise reference. In some configurations, the sustained polyphonic noise detection indicator may activate sustained polyphonic noise reference generation. For example, the music noise detector 108 may provide a sustained polyphonic noise indicator indicating that a polyphonic noise is occurring in the input audio 104 when a polyphonic noise is sustained over some period of time. Accordingly, sustained polyphonic noise reference generation may be activated when a sustained polyphonic noise is detected.

When sustained polyphonic noise reference generation is active, the music noise reference generator 117 may utilize the extracted features and/or the spectrogram to generate the polyphonic noise reference. The extracted features may be signal information corresponding to the polyphonic noise. For example, the extracted features may include temporal and/or spectral information corresponding to the sustained polyphonic noise. For instance, the music noise detector 108 may determine one or more subbands that include sustained polyphonic noise. The music noise reference generator 117 may utilize one or more fast Fourier transform (FFT) bins in the one or more subbands for sustained polyphonic noise reference generation. Accordingly, the extracted features may be a frequency-domain signal and/or a time-domain signal of a guitar or trumpet extracted from the input audio 104, for example.

When music noise is detected (as indicated by the beat indicator, the sustained polyphonic noise indicator and/or the noise characteristic 114, for example), the music noise reference generator 117 may generate a music noise reference. The music noise reference may include the rhythmic noise reference, the polyphonic noise reference or a combination of both. For example, if only rhythmic noise is detected, the music noise reference may only include the rhythmic noise reference. If only sustained polyphonic noise is detected, the music noise reference may only include the sustained polyphonic noise reference. If both rhythmic noise and sustained polyphonic noise are detected, then the music noise reference may include a combination of both. In some configurations, the music noise reference generator 117 may generate the music noise reference by summing the rhythmic noise reference and the sustained polyphonic noise reference. Additionally or alternatively, the music noise reference generator 117 may weight one or more of the rhythmic noise reference and the polyphonic noise reference. The one or more weights may be based on the strength of the rhythmic noise and/or the polyphonic noise detected, for example.

The spatial noise reference generator 112 may generate a spatial noise reference based on the input audio 104. For example, the spatial noise reference generator 112 may utilize two or more channels of the input audio 104 to generate the spatial noise reference. The spatial noise reference generator 112 may operate based on an assumption that target speech is more directional than distributed noise when the target speech is captured within a certain distance from the target speech source (e.g., within approximately 3 feet or an “arm's length” distance). The spatial noise reference may be additionally or alternatively referred to as a “non-stationary noise reference.” For example, the non-stationary noise reference may be utilized to suppress non-stationary noise based on the spatial properties of the non-stationary noise.

In one approach, the spatial noise reference generator 112 may discriminate noise from speech based on directionality, regardless of the DOA for the sound sources. For example, the spatial noise reference generator 112 may enable automatic target sector tracking based on directionality combined with harmonicity. A “target sector” may be an angular range that includes target speech (e.g., that includes a direction of the source of target speech). The angular range may be relative to the capturing device.

As used herein, the term “harmonicity” may refer to the nature of the harmonics. For example, the harmonicity may refer to the number and quality of the harmonics of an audio signal. For example, an audio signal with strong harmonicity may have many well-defined multiples of the fundamental frequency. In some configurations, the spatial noise reference generator 112 may determine a harmonic product spectrum (HPS) in order to measure the harmonicity. The harmonicity may be normalized based on a minimum statistic. Speech signals tend to exhibit strong harmonicity. Accordingly, the spatial noise reference generator 112 may constrain target sector switching only to the harmonic source.

In some configurations, the spatial noise reference generator 112 may determine the harmonicity of audio signals over a range of directions (e.g., in multiple sectors). For example, the spatial noise reference generator 112 may select a target sector corresponding to an audio signal with harmonicity that is above a harmonicity threshold. For instance, the target sector may correspond to an audio signal with harmonicity above the harmonicity threshold and with a fundamental frequency that falls within a particular pitch range. It should be noted that some sounds (e.g., music) may exhibit strong harmonicity but may have pitches that fall outside of the human vocal range or outside of the typical vocal range of a particular user. In some approaches, the electronic device may obtain a pitch histogram that indicates one or more ranges of voiced speech. The pitch histogram may be utilized to determine whether an audio signal is voiced speech by determining whether the pitch of an audio signal falls within the range of voiced speech. Sectors with audio signals outside the range of voiced speech may not be target sectors.

In some configurations, target sector switching may be additionally or alternatively based on other voice activity detector (VAD) information. For example, other voice activity detection (in addition to or alternatively from harmonicity-based voice activity detection) may be utilized to determine whether to select a particular sector as a target sector. For example, a sector may only be selected as a target sector if both the harmonicity-based voice activity detection and an additional voice activity detection scheme indicate voice activity corresponding to the sector.

The spatial noise reference generator 112 may generate the spatial noise reference based on the target sector and/or target speech. For example, once a target sector or target speech is determined, the spatial noise reference generator 112 may null out the target sector or target speech to generate the spatial noise reference. The spatial noise reference may correspond to noise (e.g., one or more diffused sources). In some configurations, the spatial noise reference generator 112 may amplify or boost the spatial noise reference.

In some configurations, the spatial noise reference may only be applied when there is a high likelihood that the target sector (e.g., target speech direction) is accurate and maintained for enough frames. For example, determining whether to apply the spatial noise reference may be based on tracking a histogram of target sectors with a proper forgetting factor. The histogram may be based on the statistics of a number of recent frames up to the current frame (e.g., 200 frames up to the current frame). The forgetting factor may be the number of frames tracked before the current frame. By only using a limited number of frames for the histogram, it can be estimated whether the target sector is maintained for enough time up to the current frame in a dynamic way.

Additionally or alternatively, if the target speech is very diffused (e.g., the target speech does not exhibit strong directionality), the spatial noise reference may not be applied. For example, if the target speech is also very diffused (because the source of target speech is too far from the capturing device), the electronic device 102 may switch to just stationary noise suppression (e.g., single microphone noise suppression) to prevent speech attenuation.

Determining whether to switch to just stationary noise suppression (e.g., to not apply the noise reference 118) may be based on a restoration ratio. The restoration ratio may indicate an amount of spectral information that has been preserved after noise suppression. For example, the restoration ratio may be defined as the ratio between the sum of noise-suppressed frequency-domain (e.g., FFT) magnitudes (of the noise-suppressed signal 122, for example) and the sum of the original frequency-domain (e.g., FFT) magnitudes (of the input audio 104, for example) at each frame. If the restoration ratio is less than a restoration ratio threshold, the noise suppressor 120 may switch to just stationary noise suppression.

Additionally or alternatively, the spatial noise reference generator 112 may generate the spatial noise reference based on an anglogram. In this approach, the spatial noise reference generator 112 may determine an anglogram. An anglogram represents likelihoods that target speech is occurring over a range of angles (e.g., DOA) over time (e.g., one or more frames). In one example, the spatial noise reference generator 112 may select a sector as a target sector if the likelihood of speech for that sector is greater than a threshold. More specifically, a threshold of the summary statistics for the likelihood per each direction may discriminate directional versus less-directional sources. Additionally or alternatively, the spatial noise reference generator 112 may measure the peakness of the directionality based on the variance of the likelihood. “Peakness” may be a similar concept as used in some voice activity detection (VAD) schemes, including estimating a noise floor and measuring the difference of the height of the current frame with the noise floor to determine if the statistic is one or zero. Accordingly, the peakness may reflect how high the value is compared to the anglogram floor, which may be tracked by averaging one or more noise-only periods. One implementation of tracking this statistic may include applying the following equation: floor=α*floor+(1−α)*currentValue (when VAD==0 or does not indicate voice activity), where floor is the anglogram floor, α is a smoothing factor (e.g., 0.95 or another value) and currentValue is the likelihood value for the current frame. The VAD may be a single-channel VAD with a very conservative setting (that does not allow a missed detection). For the single-channel VAD, an energy-based band based on minimum statistics and onset/offset VAD may be used. In some configurations, the spatial noise reference generator 112 may null out the target sector and/or a directional source (that was determined based on the anglogram) in order to obtain the spatial noise reference.

Additionally or alternatively, the spatial noise reference generator 112 may generate the spatial noise reference based on a near-field attribute. When target speech is captured within a certain distance (e.g., approximately 3 feet or an “arm's length” distance) from the source, the target speech may exhibit an approximately consistent level offset up to a certain frequency depending on the distance to the source (e.g., user, speaker) from each microphone. However, far-field sound (e.g., a far-field source, noise, etc.) may not exhibit a consistent level offset.

In addition to the target sector determination scheme described above, this information may be utilized to further refine the target sector detection as well as to generate a noise reference based on inter-microphone subtraction with half-rectification. In one implementation, if a first channel of the input audio 104 (e.g., “mic1”) has an approximately consistent higher level than a second channel of the input audio 104 (e.g., “mic2”) up to a certain frequency, the spatial noise reference may be generated in accordance with |mic2|−|mic1|, where negative values per frequency bins may be set to 0. In another implementation, the entire frame may be included in the spatial noise reference if differences at peaks (between channels of the input audio 104) meet the far-field condition.

In some configurations, the spatial noise reference generator 112 may measure peak variability based on the mean and variance of the log amplitude difference between a first channel (e.g., the primary channel) and a second channel (e.g., a secondary channel) of the input audio 104 at each peak. The spatial noise reference generator 112 may detect a source of the input audio 104 as a diffused source when the mean is near zero (e.g., lower than a threshold) and the variance is greater than a variance threshold.

The noise reference determiner 116 may determine the noise reference 118 based on the noise characteristic 114, the music noise reference and/or the spatial noise reference. For example, if the noise characteristic 114 indicates stationary noise, then the noise reference determiner 116 may exclude any spatial noise reference from the noise reference 118. Excluding the spatial noise reference from the noise reference may mean that the noise reference 118, if any, is not based on the spatial noise reference. For example, the noise reference 118 may be a reference signal that is used by a Wiener filter in the noise suppressor 120 to suppress noise in the input audio 104. When the spatial noise reference is excluded, the noise suppression performed by the noise suppressor 120 is not based on spatial noise information (e.g., is not based on a noise reference that is produced from multiple input audio 104 channels or microphones). For example, any noise suppression may only include stationary noise suppression based on a single channel of input audio 104 when the spatial noise reference is excluded. Additionally, if the noise characteristic 114 indicates stationary noise, then the noise reference determiner 116 may exclude any music noise reference from the noise reference 118. If the noise characteristic 114 indicates that the noise is not stationary noise and is not music noise, then the noise reference determiner 116 may only include the spatial noise reference in the noise reference 118. If the noise characteristic 114 indicates that the noise is music noise, then the noise reference determiner 116 may include the spatial noise reference and the music noise reference in the noise reference 118. For example, the noise reference determiner 116 may combine the spatial noise reference and the music noise reference (with or without weighting) to generate the noise reference 118. The noise reference 118 may be provided to the noise suppressor 120.

The noise suppressor 120 may suppress noise in the input audio 104 based on the noise reference 118 and the noise characteristic 114. In some configurations, the noise suppressor 120 may utilize a Wiener filtering approach to suppress noise in the input audio 104. The “Wiener filtering approach” may refer generally to all similar methods, where the noise suppression is based on the estimation of SNR.

If the noise characteristic 114 indicates stationary noise, the noise suppressor 120 may perform stationary noise suppression on the input audio 104, which does not require a spatial noise reference. If the noise characteristic 114 indicates that the noise is not stationary noise and is not music noise, then the noise suppressor 120 may apply the noise reference 118, which includes the spatial noise reference. For example, the noise suppressor 120 may apply the noise reference 118 to a Wiener filter in order to suppress non-stationary noise in the input audio 104. If the noise characteristic 114 indicates music noise, then the noise suppressor 120 may apply the noise reference 118, which includes the spatial noise reference and the music noise reference. For example, the noise suppressor 120 may apply the noise reference 118 to a Wiener filter in order to suppress non-stationary noise and music noise in the input audio 104. Accordingly, the noise suppressor 120 may produce the noise-suppressed signal 122 by suppressing noise in the input audio 104 in accordance with the noise characteristic 114.

The noise suppressor 120 may remove undesired noise (e.g., interference) from the input audio 104 (e.g., one or more microphone signals). However, the noise suppression may be tailored based on the type of noise being suppressed. As described above, different techniques may be used for stationary versus non-stationary noise. For example, if a user is holding a dual-microphone electronic device 102 away from their face (in a “browse talk” mode, for instance), it may be difficult to distinguish between the DOA of target speech and the DOA of noise, thus making it difficult to suppress the noise.

Therefore, the noise characteristic determiner 106 may determine the noise characteristic 114, which may be utilized to tailor the noise suppression applied by the noise suppressor 120. In other words, the noise suppression may be performed as a function of the noise type detection. Specifically, a music noise detector 108 may detect whether noise is of a music type and a stationary noise detector 110 may detect whether noise is of a stationary type. Additionally, the noise reference determiner 116 may determine a noise reference 118 that may be utilized during noise suppression.

The electronic device 102 may transmit, store and/or output the noise-suppressed signal 122. In some configurations, the electronic device 102 may encode, modulate and/or transmit the noise-suppressed signal 122 in a wireless and/or wired transmission. For example, the electronic device 102 may be a phone (e.g., cellular phone, smart phone, landline phone, etc.) that may transmit the noise-suppressed signal 122 as part of a phone call. Additionally or alternatively, the electronic device 102 may store the noise-suppressed signal 122 in memory and/or output the noise-suppressed signal 122. For example, the electronic device 102 may be a voice recorder that records the noise-suppressed signal 122 and plays back the noise-suppressed signal 122 over one or more speakers.

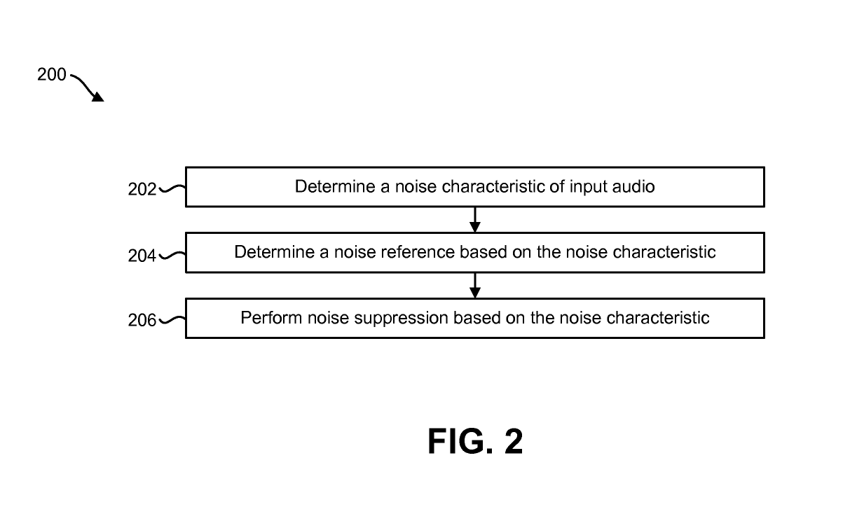

FIG. 2 is a flow diagram illustrating one configuration of a method 200 for noise characteristic dependent speech enhancement. The electronic device 102 may determine 202 a noise characteristic 114 of input audio 104. This may be accomplished as described above in connection with FIG. 1. For example, determining 202 the noise characteristic may include determining whether noise is stationary noise. To determine whether noise is stationary noise, for instance, the electronic device 102 may measure the spectral flatness of each frame of one or more channels of the input audio 104 and detect frames that meet a spectral flatness criterion as including stationary noise.

The electronic device 102 may determine 204 a noise reference 118 based on the noise characteristic 114. This may be accomplished as described above in connection with FIG. 1. For example, determining 204 the noise reference 118 based on the noise characteristic 114 may include excluding a spatial noise reference from the noise reference 118 when the noise is stationary noise (e.g., when the noise characteristic 114 indicates that the noise is stationary noise). In this case, for instance, the noise reference 118 produced by the noise reference determiner 116, if any, will not include the spatial noise reference.

The electronic device 102 may perform 206 noise suppression based on the noise characteristic 114. This may be accomplished as described above in connection with FIG. 1. For example, if the noise characteristic 114 indicates stationary noise, the noise suppressor 120 may perform stationary noise suppression on the input audio 104. If the noise characteristic 114 indicates that the noise is not stationary noise and is not music noise, then the noise suppressor 120 may apply the noise reference 118, which includes the spatial noise reference. If the noise characteristic 114 indicates music noise, then the noise suppressor 120 may apply the noise reference 118, which includes the spatial noise reference and the music noise reference.

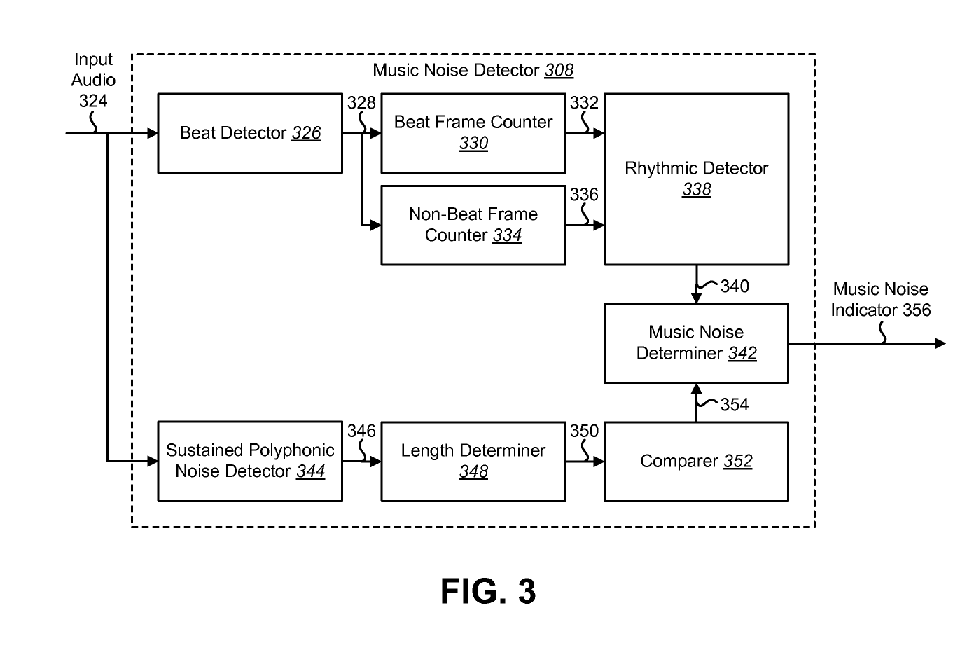

FIG. 3 is a block diagram illustrating one configuration of a music noise detector 308. The music noise detector 308 described in connection with FIG. 3 may be one example of the music noise detector 108 described in connection with FIG. 1. The music noise detector 308 may determine whether noise in the input audio 324 (e.g., a microphone input signal) is music noise. In other words, the music noise detector 308 may detect music noise. The music noise detector 308 may include a beat detector 326 (e.g., a drum detector), a beat frame counter 330, a non-beat frame counter 334, a rhythmic detector 338, a sustained polyphonic noise detector 344, a length determiner 348, a comparer 352 and a music noise determiner 342. For example, the music noise detector 308 includes two branches: one to determine whether noise is rhythmic noise, such as a drum beat, and one to determine whether noise is sustained polyphonic noise, such as a guitar playing.

The beat detector 326 may detect a beat in an input audio 324 frame. The beat detector 326 may provide a frame beat indicator 328, which indicates whether a beat was detected in a frame. The beat frame counter 330 may count the frames with a detected beat within a beat detection time interval based on the frame beat indicator 328. The beat frame counter 330 may provide the counted number of beat frames 332 to the rhythmic detector 338. A non-beat frame counter 334 may count frames in between detected beats based on the frame beat indicator 328. The non-beat frame counter 334 may provide the counted number of non-beat frames 336 to the rhythmic detector 338. Based on the number of beat frames 332 and the number of non-beat frames 336, the rhythmic detector 338 may determine whether there is a regular rhythmic structure in the input audio 324. For example, the rhythmic detector 338 may determine whether a regularly recurring pattern is indicated by the number of beat frames 332 and the number of non-beat frames 336. The rhythmic detector 338 may provide a rhythmic noise indicator 340 to the music noise determiner 342. For example, the rhythmic noise indicator 340 indicates whether a regular rhythmic structure is occurring in the input audio 324. A regular rhythmic structure suggests that there may be rhythmic music noise to suppress.

The sustained polyphonic noise detector 344 may detect sustained polyphonic noise based on the input audio 324. For example, the sustained polyphonic noise detector 344 may evaluate the power spectrum in a frame of the input audio 324 to determine if polyphonic noise is detected. The sustained polyphonic noise detector 344 may provide a frame sustained polyphonic noise indicator 346 to the length determiner 348. The frame sustained polyphonic noise indicator 346 indicates whether sustained polyphonic noise was detected in a frame of the input audio 324. The length determiner 348 may track a length of time during which the polyphonic noise is present (in number of frames, for example). The length determiner 348 may indicate the length 350 (in time or frames, for instance) of polyphonic noise to the comparer 352. The comparer 352 may then determine if the length is long enough to classify the polyphonic noise as sustained polyphonic noise. For example, the comparer 352 may compare the length 350 to a length threshold. If the length 350 is greater than the length threshold, the comparer 352 may accordingly determine that the detected polyphonic noise is long enough to classify it as sustained polyphonic noise. The comparer 352 may provide a sustained polyphonic noise indicator 354 that indicates whether sustained polyphonic noise was detected.

The sustained polyphonic noise indicator 354 and the rhythmic noise indicator 340 may be provided to the music noise determiner 342. The music noise determiner 342 may combine the sustained polyphonic noise indicator 354 and the rhythmic noise indicator 340 to output a music noise indicator 356, which indicates whether music noise is detected in the input audio 324. For example, the sustained polyphonic noise indicator 354 and the rhythmic noise indicator 340 may be combined in accordance with a logical AND, a logical OR, a weighted sum, etc.

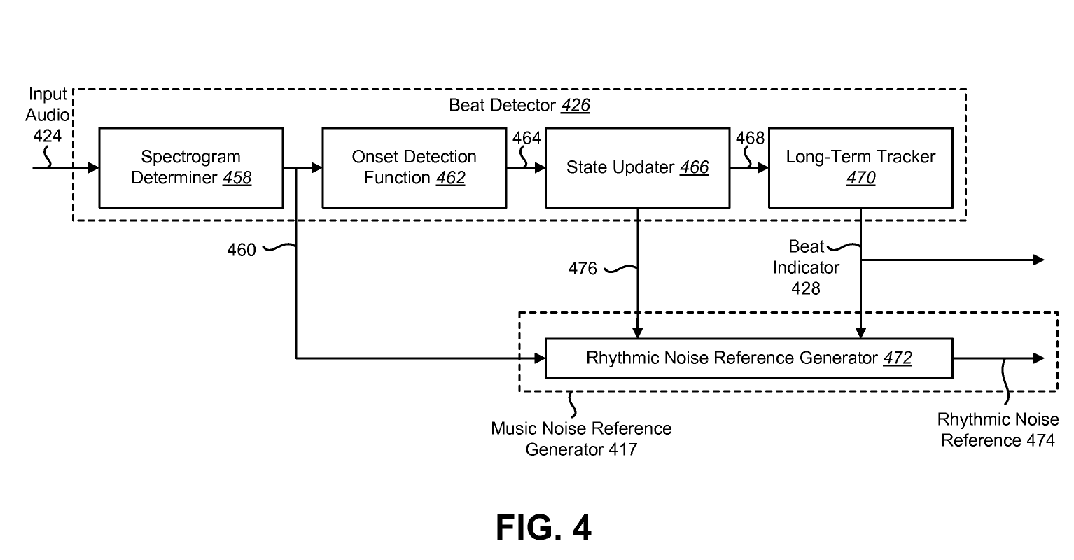

FIG. 4 is a block diagram illustrating one configuration of a beat detector 426 and a music noise reference generator 417. The beat detector 426 described in connection with FIG. 4 may be one example of the beat detector 326 described in connection with FIG. 3. The music noise reference generator 417 described in connection with FIG. 4 may be one example of the music noise reference generator 117 described in connection with FIG. 1.

The beat detector 426 may detect a beat (e.g., drum sounds, percussion sounds, etc.). The beat detector 426 may include a spectrogram determiner 458, an onset detection function 462, a state updater 466 and a long-term tracker 470. It should be noted that the onset detection function 462 may be implemented in hardware (e.g., circuitry) or a combination of hardware and software. The spectrogram determiner 458 may determine a spectrogram 460 based on the input audio 424. For example, the spectrogram determiner 458 may perform a short-time Fourier transform (STFT) on the input audio 424 to determine the spectrogram 460. The spectrogram 460 may be provided to the onset detection function 462 and to the music noise reference generator 417 (e.g., a rhythmic noise reference generator 472).

The onset detection function 462 may be used to determine the onset of a beat based on the spectrogram 460. The onset detection function 462 may be computed using energy fluctuation of each frame or temporal difference of spectral features (e.g., Mel-frequency spectrogram, spectral roll-off or spectral centroid). In some configurations, the beat detector 426 may utilize soft information rather than a determined onset/offset (e.g., 1 or 0).

The onset detection function 462 provides an onset indicator 464 to the state updater 466. The onset indicator 464 indicates a confidence measure of onsets for the current frame. The state updater 466 tracks the onset indicator 464 over one or more subsequent frames to ensure the presence of the beat. The state updater 466 may provide spectral features 476 (e.g., part of or the whole current spectral frame) to the music noise reference generator 417 (e.g., to a rhythmic noise reference generator 472). The state updater 466 may also provide a state update indicator 468 to the long-term tracker 470 when the state is updated.

The long-term tracker 470 may provide a beat indicator 428 that indicates when a beat is detected regularly. For example, when the state update indicator 468 indicates a regular update, the long-term tracker 470 may indicate that a beat is detected regularly. In some configurations, the beat indicator 428 may be provided to a beat frame counter 330 and to a non-beat frame counter as described above in connection with FIG. 3.

The music noise reference generator 417 may include a rhythmic noise reference generator 472. When a beat is detected regularly, the long-term tracker 470 activates the rhythmic noise reference generator 472 (via the beat indicator 428, for example). When activated (e.g., when the beat is detected regularly), the beat noise reference generator may determine a rhythmic noise reference 474. The music noise reference generator 417 may utilize the rhythmic noise reference 474 (e.g., beat noise reference, drum noise reference) to generate a music noise reference (in addition to or alternatively from a sustained polyphonic noise reference, for example). The noise suppressor 120 may suppress noise based on the music noise reference.

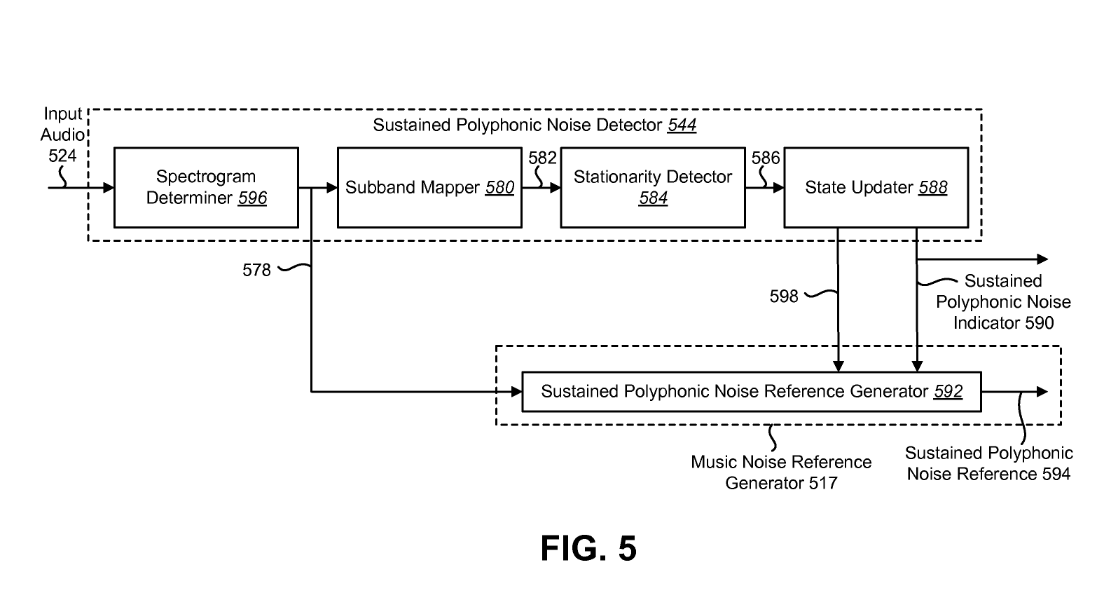

FIG. 5 is a block diagram illustrating one configuration of a sustained polyphonic noise detector 544 and a music noise reference generator 517. The sustained polyphonic noise detector 544 described in connection with FIG. 5 may be one example of the sustained polyphonic noise detector 344 described in connection with FIG. 3. The music noise reference generator 517 described in connection with FIG. 5 may be one example of the music noise reference generator 517 described in connection with FIG. 1. The music noise reference generator 517 may include a sustained polyphonic noise reference generator 592.

The sustained polyphonic noise detector 544 may detect a sustained polyphonic noise. The sustained polyphonic noise detector 544 may include a spectrogram determiner 596, a subband mapper 580, a stationarity detector 584 and a state updater 588. The spectrogram determiner 596 may determine a spectrogram 578 (e.g., a power spectrogram) based on the input audio 524. For example, the spectrogram determiner 596 may perform a short-time Fourier transform (STFT) on the input audio 524 to determine the spectrogram 578. The spectrogram 578 may be provided to the subband mapper 580 and to the music noise reference generator 517 (e.g., sustained polyphonic noise reference generator 592).

The subband mapper 580 may map the spectrogram 578 (e.g., power spectrogram) to a group of subbands 582 with center frequencies that are logarithmically scaled (e.g., a Bark scale). The subbands 582 may be provided to the stationarity detector 584.

The stationarity detector 584 may detect stationarity for each of the subbands 582. For example, the stationarity detector 584 may detect the stationarity based on an energy ratio between a high-pass filter output and an input for each respective subband 582. The stationarity detector 584 may provide a stationarity indicator 586 to the state updater 588. The stationarity indicator 586 indicates stationarity in one or more of the subbands.

The state updater 588 may track features from the input audio 524 corresponding for each subband that exhibits stationarity (as indicated by the stationarity indicator 586, for example). The state updater 588 may track the stationarity for each subband. The stationarity may be tracked over one or more subsequent frames (e.g., two, three, four, five, etc.) to ensure that the subband energy is sustained. For example, if the stationarity indicator 586 consistently indicates stationarity for a particular subband for a threshold number of frames, the state updater 588 may provide the tracked features 598 corresponding to the subband to the music noise reference generator 517 (e.g., to the sustained polyphonic noise reference generator 592). For example, once the subband is determined to be sustained, fast Fourier transform (FFT) bins in the subband may be provided to the sustained polyphonic noise reference generator 592. Additionally, the state updater 588 may provide a sustained polyphonic noise indicator 590 to the sustained polyphonic noise reference generator 592. In some configurations, the sustained polyphonic noise indicator 590 may be a frame sustained polyphonic noise indicator.

When one or more subbands are determined to be sustained, the state updater 588 may activate the sustained polyphonic noise reference generator 592 (via the sustained polyphonic noise indicator 590, for example). The sustained polyphonic noise reference generator 592 may determine (e.g., generate) a sustained polyphonic noise reference 594 based on the tracking. For example, the sustained polyphonic noise reference generator 592 may use the features 598 (e.g., FFT bins of one or more subbands) to generate the sustained polyphonic noise reference 594 (e.g., a sustained tone-based noise reference). The music noise reference generator 517 may utilize the sustained polyphonic noise reference 594 to generate a music noise reference (in addition to or alternatively from a rhythmic noise reference, for example). The noise suppressor 120 may suppress noise based on the music noise reference.

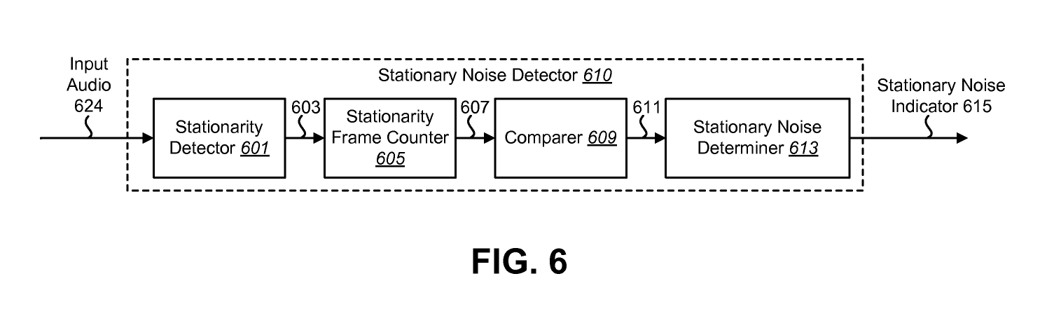

FIG. 6 is a block diagram illustrating one configuration of a stationary noise detector 610. The stationary noise detector 610 described in connection with FIG. 6 may be one example of the stationary noise detector 110 described in connection with FIG. 1. The stationary noise detector 610 may include a stationarity detector 601, a stationarity frame counter 605, a comparer 609 and a stationary noise determiner 613. The stationarity detector 601 may determine stationarity for a frame based on the input audio 624. In general, stationary noise will typically be more spectrally flat than non-stationary noise. In one example, the stationarity detector 601 may determine stationarity for a frame based on a spectral flatness measure of noise. For example, the spectral flatness measure (sfm) may be determined in accordance with Equation (1).

sfm=10^{(mean(log}^{₁₀}^{(normalized}^{_{—}}^{power}^{_{—}}^{spectrum)))} (1)

In Equation (1), normalized_power_spectrum is the normalized power spectrum of the input audio 624 and mean( ) is a function that finds the mean of log₁₀ (normalized_power_spectrum). If the sfm meets a spectral flatness criterion (e.g., a spectral flatness threshold), then the stationarity detector 601 may determine that the corresponding frame includes stationary noise. The stationarity detector 601 may provide a frame stationarity indicator 603 that indicates whether the stationarity is detected for each frame. The frame stationarity indicator 603 may be provided to the stationarity frame counter 605.

The stationarity frame counter 605 may count the frames with detected stationarity within a stationary noise detection time interval (e.g., 5, 10, 200 frames, etc.) The stationarity frame counter 605 may provide the (counted) number of frames 607 with detected stationarity to the comparer 609.

The comparer 609 may compare the number of frames 607 to a stationary noise detection threshold. The comparer 609 may provide a threshold indicator 611 to the stationary noise determiner 613. The threshold indicator 611 may indicate whether the number of frames 607 is greater than the stationary noise detection threshold.

The stationary noise determiner 613 may determine whether stationary noise is detected based on the threshold indicator 611. For example, if the number of frames 607 is greater than the stationary noise detection threshold, the stationary noise determiner 613 may determine that stationary noise is occurring in the input audio 624 (e.g., may detect stationary noise). The stationary noise determiner 613 may provide a stationary noise indicator 615. The stationary noise indicator 615 may indicate whether stationary noise is detected.

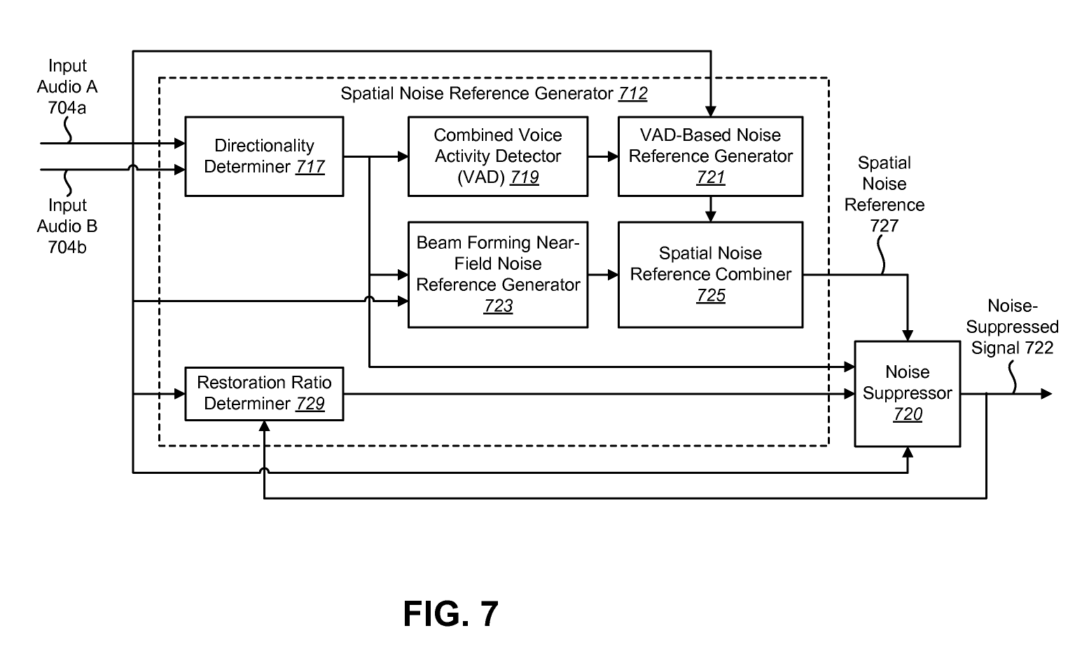

FIG. 7 is a block diagram illustrating one configuration of a spatial noise reference generator 712. The spatial noise reference generator 712 described in connection with FIG. 7 may be one example of the spatial noise reference generator 112 described in connection with FIG. 1. The spatial noise reference generator 712 may include a directionality determiner 717, an optional combined VAD 719, an optional VAD-based noise reference generator 721, a beam forming near-field noise reference generator 723, a spatial noise reference combiner 725 and a restoration ratio determiner 729. The spatial noise reference generator 712 may be coupled to a noise suppressor 720. The noise suppressor 720 described in connection with FIG. 7 may be one example of the noise suppressor 120 described in connection with FIG. 1.

In some configurations, the noise suppression may be tailored based on the directionality of a signal. The directionality of target speech may be determined based on multiple channels of input audio 704a-b (from multiple microphones, for example). As used herein, the term “directionality” may refer to a metric that indicates a likelihood that a signal (e.g., target speech) comes from a particular direction (relative to the electronic device 102, for example). It may be assumed that target speech is more directional than distributed noise within a certain distance (e.g., approximately 3 feet or an “arm's length”) from the electronic device 102.

The directionality determiner 717 may receive multiple channels of input audio 704a-b. For example, input audio A 704a may be a first channel of input audio and input audio B 704b may be a second channel of input audio. Although only two channels of input audio 704a-b are illustrated in FIG. 7, more channels may be utilized. The directionality determiner 717 may determine directionality of target speech. For example, the directionality determiner 717 may discriminate noise from target speech based on directionality.

In some configurations, the directionality determiner 717 may determine directionality of target speech based on an anglogram. For example, the directionality determiner 717 may determine an anglogram based on the multiple channels of input audio 704a-b. The anglogram may provide likelihoods that target speech is occurring over a range of angles (e.g., DOA) over time. The directionality determiner 717 may select a target sector based on the likelihoods provided by the anglogram. This may include setting a threshold of the summary statistics for the likelihood for each direction to discriminate directional and non-directional sources. The determination may also be based on the variance of the likelihood to measure the peakness of the directionality.

Additionally, the directionality determiner 717 may perform automatic target sector tracking that is based on directionality combined with harmonicity. Harmonicity may be utilized to constrain target sector switching only to a harmonic source (e.g., the target speech). For example, even if a source is very directional, it may still be considered noise if it is not very harmonic (e.g., if it has harmonicity that is lower than a harmonicity threshold). Any additional or alternative kind of voice activity detection information may be combined with directionality detection to constrain target sector switching. The directionality determiner 717 may provide directionality information to the optional combined voice activity detector (VAD) 719, to the beam forming near-field noise reference generator 723 and/or to the noise suppressor 720. The directionality information may indicate directionality (e.g., target sector, angle, etc.) of the target speech.

The beam forming near-field noise reference generator 723 may generate a beamformed noise reference based on the directionality information and the input audio 704 (e.g., one or more channels of the input audio 704a-b). For example, the beam forming near-field noise reference generator 723 may generate the beamformed noise reference for diffuse noise by nulling out target speech. In some configurations, the beamformed noise reference may be amplified (e.g., boosted). The beamformed noise reference may be provided to the spatial noise reference combiner 725.

The optional combined VAD 719 may detect voice activity in the input audio 704 based on the directionality information. The combined VAD 719 may provide a voice activity indicator to the VAD-based noise reference generator 721. The voice activity indicator indicates whether voice activity is detected. In some configurations, the combined VAD 719 is a combination of a single channel VAD (e.g., minimum-statistics based energy VAD, onset/offset VAD, etc.) and a directional VAD based on the directionality. This may result in improved voice activity detection based on the directionality-based VAD.

The VAD-based noise reference generator 721 may generate a VAD-based noise reference based on the voice activity indicator and the input audio 704 (e.g., input audio A 704a). The VAD-based noise reference may be provided to the spatial noise reference combiner 725. The VAD-based noise reference generator 721 may generate the VAD-based noise reference based on a VAD (e.g., the combined VAD 719). For example, when the combined VAD 719 does not indicate voice activity (e.g., VAD==0), the VAD-based noise reference generator 721 may generate the VAD-based noise reference 721 with some smoothing. For example, nref=β*nref+(1−β)*InputMagnitudeSpectrum, where nref is the VAD-based noise reference, β is a smoothing factor and InputMagnitudeSpectrum is the magnitude spectrum of input audio A 704a. Furthermore, when the combined VAD 719 indicates voice activity (e.g., VAD==1), updating may be frozen (e.g., the VAD-based noise reference is not updated).

The spatial noise reference combiner 725 may combine the beamformed noise reference and the VAD-based noise reference to produce a spatial noise reference 727. For example, the spatial noise reference combiner 725 may sum (with or without one or more weights) the beamformed noise reference and the VAD-based noise reference.

The spatial noise reference 727 may be provided to the noise suppressor 720. However, the spatial noise reference 727 may only be applied when there is a high level of confidence that the target speech direction is accurate and maintained for enough frames by tracking a histogram of target sectors with a proper forgetting factor.

The restoration ratio determiner 729 may determine whether to fall back to stationary noise suppression (e.g., single-microphone noise suppression) for diffused target speech in order to prevent target speech attenuation. For example, if the target speech is very diffused (due to source of target speech being too distant from the capturing device), stationary noise suppression may be used to prevent target speech attenuation. Determining whether to fall back to stationary noise suppression may be based on the restoration ratio (e.g., a measure of spectrum following noise suppression to a measure of spectrum before noise suppression). For example, the restoration ratio determiner 729 may determine the ratio between the sum of noise-suppressed frequency-domain (e.g., FFT) magnitudes (of the noise-suppressed signal 722, for example) and the sum of the original frequency-domain (e.g., FFT) magnitudes (of the input audio 704, for example) at each frame. If the restoration ratio is less than a restoration ratio threshold, the noise suppressor 720 may switch to just stationary noise suppression.

The noise suppressor 720 may produce a noise-suppressed signal 722. For example, the noise suppressor 720 may suppress spatial noise indicated by the spatial noise reference 727 from the input audio 704 unless the restoration ratio is below a restoration ratio threshold.

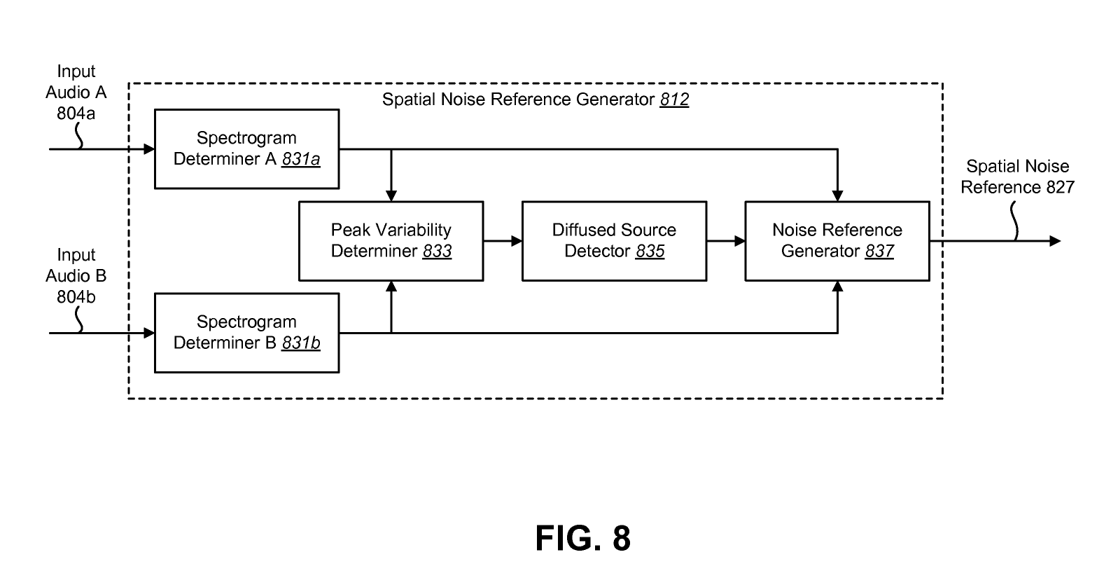

FIG. 8 is a block diagram illustrating another configuration of a spatial noise reference generator 812. The spatial noise reference generator 812 (e.g., near-field target based noise reference generator) described in connection with FIG. 8 may be another example of the spatial noise reference generator 112 described in connection with FIG. 1. The spatial noise reference generator 812 may include spectrogram determiner A 831a, spectrogram determiner B 831b, a peak variability determiner 833, a diffused source detector 835 and a noise reference generator 837.

Within a particular distance (e.g., approximately 3 feet or an “arm's length” distance) to the capturing device, target speech tends to exhibit a relatively consistent level offset up to a certain frequency depending on the distance to the speaker from each microphone. However, a far-field source tends to not have the consistent level offset. In combination with a target sector detection scheme (as described above, for example), this information may be utilized to further refine the target sector detection as well as to create a spatial noise reference based on inter-microphone subtraction with half-rectification. In one implementation, if input audio A 804a (e.g., “mic1”) has an approximately consistent higher level than input audio B 804b (e.g., “mic2”) up to a certain frequency, the spatial noise reference 827 may be generated in accordance with |mic2″−|mic1|, where negative values per frequency bins may be set to 0. In another implementation, the entire frame may be included in the spatial noise reference 827 if differences at peaks (between channels of the input audio 804) meet the far-field condition (e.g., lack a consistent level offset). Accordingly, the spatial noise reference 827 may be determined based on a level offset.

In the configuration illustrated in FIG. 8, spectrogram determiner A 831a and spectrogram determiner B 831b may determine spectrograms for input audio A 804a and input audio B 804b (e.g., primary and secondary microphone channels), respectively. The peak variability determiner 833 may determine peak variability based on the spectrograms. For example, peak variability may be measured using the mean and variance between the log amplitude difference between the spectrograms at each peak. The peak variability may be provided to the diffused source detector 835.

The diffused source detector 835 may determine whether a source is diffused based on the peak variability. For example, a source of the input audio 804 may be detected as a diffused source when the mean is near zero (e.g., lower than a threshold) and the variance is greater than a variance threshold. The diffused source detector 835 may provide a diffused source indicator to the noise reference generator 837. The diffused source indicator indicates whether a diffused source is detected.

The noise reference generator 837 may generate a spatial noise reference 827 that may be used during noise suppression. For example, the noise reference generator 837 may generate the spatial noise reference 827 based on the spectrograms and the diffused source indicator. In this case, the spatial noise reference 827 may be a diffused source detection-based noise reference.

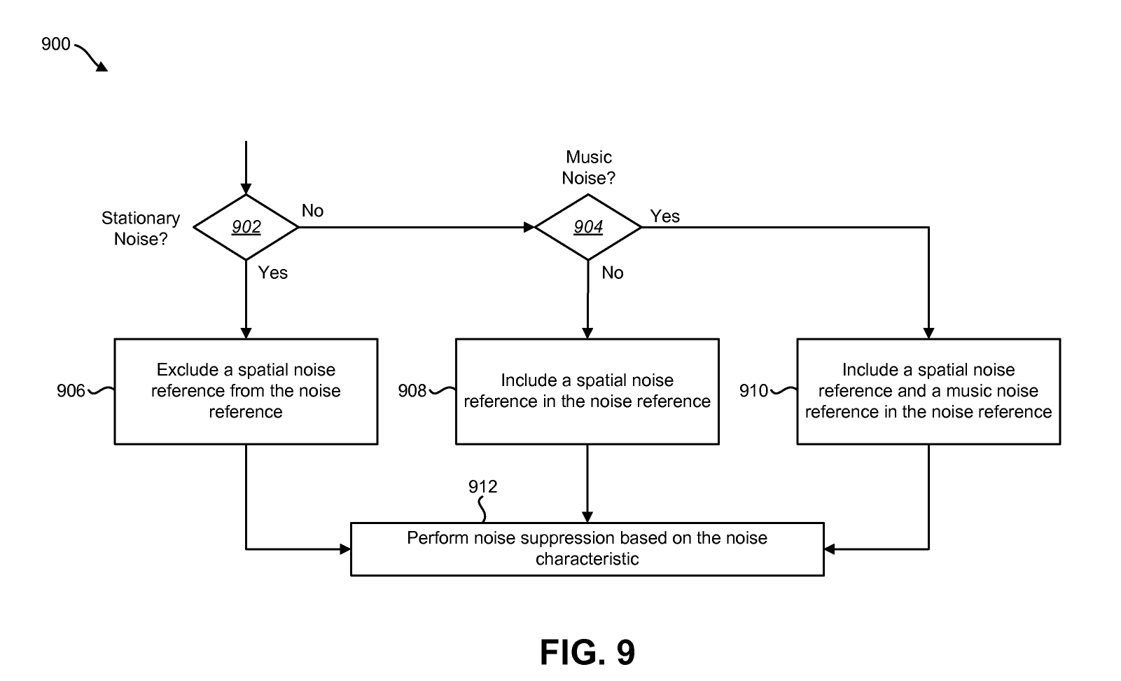

FIG. 9 is a flow diagram illustrating one configuration of a method 900 for noise characteristic dependent speech enhancement. The method 900 may be performed by the electronic device 102. The electronic device 102 may obtain input audio 104 (e.g., a noisy signal). The electronic device 102 may determine whether noise (included in the input audio 104) is stationary noise. For example, the electronic device 102 may determine 902 whether the noise is stationary noise as described above in connection with FIG. 6.

When the noise is stationary, the electronic device 102 may exclude 906 a spatial noise reference from the noise reference 118. For example, the electronic device 102 may exclude the spatial noise reference from the noise reference 118, if any. Accordingly, the electronic device 102 may reduce noise suppression aggressiveness. For instance, suppressing stationary noise may not require the spatial noise reference or spatial filtering (e.g., aggressive noise suppression). This is because only a stationary noise reference may be used to capture enough noise signal for noise suppression. For example, when only stationary noise is detected, the noise reference 118 may only include a stationary noise reference. In some configurations, the noise reference determiner 116 may generate the stationary noise reference. Accordingly, the noise reference 118 may include a stationary noise reference when stationary noise is detected. The electronic device 102 may accordingly perform 912 noise suppression based on the noise characteristic 114. For example, the electronic device 102 may only perform stationary noise suppression when the noise is stationary noise.

If the noise is not stationary noise, the electronic device 102 may determine 904 whether the noise is music noise. For example, the electronic device 102 may determine 904 whether the noise is music noise as described above in connection with one or more of FIGS. 3-5.

When the noise is not music noise (and is not stationary noise), the electronic device 102 may include 908 a spatial noise reference in the noise reference 118. For example, the noise reference 118 may be the spatial noise reference in this case. When the noise reference includes the spatial noise reference, the noise suppressor 120 may utilize more aggressive noise suppression (e.g., spatial filtering) in comparison to stationary noise suppression. The electronic device 102 may accordingly perform 912 noise suppression based on the noise characteristic 114. For example, the electronic device 102 may perform non-stationary noise suppression when the noise is not music noise and is not stationary noise. More specifically, the electronic device 102 may apply the spatial noise reference as the noise reference 118 for Wiener filtering noise suppression in some configurations.

When the noise is music noise (and is not stationary noise), the electronic device 102 may include 910 the spatial noise reference and the music reference in the noise reference 118. For example, the noise reference 118 may be a combination of the spatial noise reference and the music noise reference in this case. The electronic device 102 may accordingly perform 912 noise suppression based on the noise characteristic 114. For example, the electronic device 102 may perform noise suppression with the spatial noise reference and the music noise reference when the noise is music noise and is not stationary noise. More specifically, the electronic device 102 may apply a combination of the spatial noise reference and the music noise reference as the noise reference 118 for Wiener filtering noise suppression in some configurations.

It should be noted that determining a noise characteristic 114 of input audio may comprise determining 902 whether noise is stationary noise and/or determining 904 whether noise is music noise. It should also be noted that determining a noise reference based on the noise characteristic 114 may comprise excluding 906 a spatial noise reference from the noise reference 118, including 908 a spatial noise reference in the noise reference 118 and/or including 910 a spatial noise reference and a music noise reference in the noise reference 118. Furthermore, determining a noise reference 118 may be included as part of determining a noise characteristic 114, as part of performing noise suppression, as part of both or may be a separate procedure.

In some configurations, determining the noise characteristic 114 may include detecting rhythmic noise, detecting sustained polyphonic noise or both. This may be accomplished as described above in connection with one or more of FIGS. 3-5 in some configurations. For example, detecting rhythmic noise may include determining an onset of a beat based on a spectrogram and tracking features corresponding to the onset of the beat for multiple frames. Determining the noise reference 118 may include determining a rhythmic noise reference when the beat is detected regularly. Additionally, detecting sustained polyphonic noise may include mapping a spectrogram to a group of subbands with center frequencies that are logarithmically scaled and detecting stationary based on an energy ratio between a high-pass filter output and input for each subband. Detecting sustained polyphonic noise may also include tracking stationarity for each subband. Determining the noise reference 118 may include determining a sustained polyphonic noise reference based on the tracking.

It should be noted that the music noise reference may include a rhythmic noise reference, a sustained polyphonic noise reference or both. For example, if rhythmic noise is detected, the music noise reference may include a rhythmic noise reference (as described in connection with FIG. 4, for example). If sustained polyphonic noise is detected, the music noise reference may include a sustained polyphonic noise reference (as described in connection with FIG. 5, for example). If both rhythmic noise and sustained polyphonic noise are detected, the music noise reference may include both a rhythmic noise reference and a sustained polyphonic noise reference.

In some configurations, determining the spatial noise reference may be determined based on directionality of the input audio, harmonicity of the input audio or both. This may be accomplished as described above in connection with FIG. 7, for example. For instance, a spatial noise reference can be generated by using spatial filtering. If the DOA for the target speech is known, then the target speech may be nulled out to capture everything except the target speech. In some configurations, a masking approach may be used, where only the target dominant frequency bins/subbands are suppressed. Additionally or alternatively, determining the spatial noise reference may be based on a level offset. This may be accomplished as described above in connection with FIG. 8, for example.

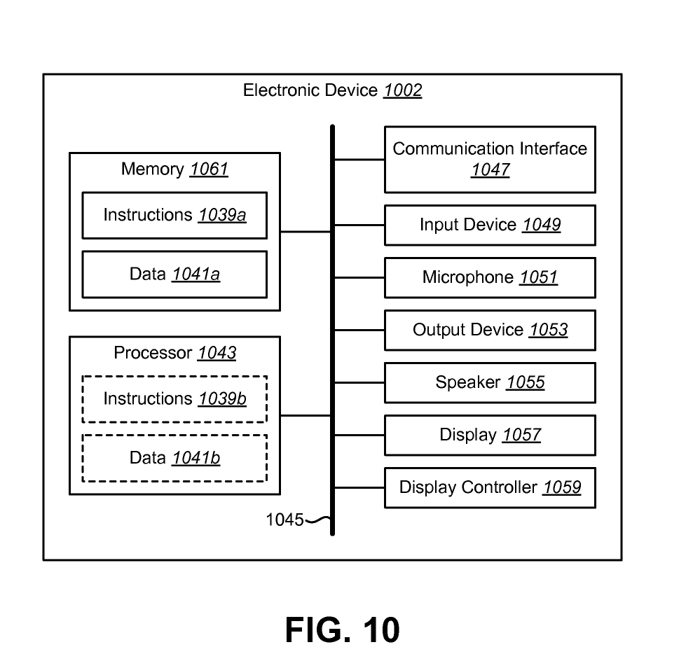

FIG. 10 illustrates various components that may be utilized in an electronic device 1002. The illustrated components may be located within the same physical structure or in separate housings or structures. The electronic device 1002 described in connection with FIG. 10 may be implemented in accordance with one or more of the electronic devices described herein. The electronic device 1002 includes a processor 1043. The processor 1043 may be a general purpose single- or multi-chip microprocessor (e.g., an ARM), a special purpose microprocessor (e.g., a digital signal processor (DSP)), a microcontroller, a programmable gate array, etc. The processor 1043 may be referred to as a central processing unit (CPU). Although just a single processor 1043 is shown in the electronic device 1002 of FIG. 10, in an alternative configuration, a combination of processors (e.g., an ARM and DSP) could be used.

The electronic device 1002 also includes memory 1061 in electronic communication with the processor 1043. That is, the processor 1043 can read information from and/or write information to the memory 1061. The memory 1061 may be any electronic component capable of storing electronic information. The memory 1061 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 1041a and instructions 1039a may be stored in the memory 1061. The instructions 1039a may include one or more programs, routines, sub-routines, functions, procedures, etc. The instructions 1039a may include a single computer-readable statement or many computer-readable statements. The instructions 1039a may be executable by the processor 1043 to implement one or more of the methods, functions and procedures described above. Executing the instructions 1039a may involve the use of the data 1041a that is stored in the memory 1061. FIG. 10 shows some instructions 1039b and data 1041b being loaded into the processor 1043 (which may come from instructions 1039a and data 1041a).

The electronic device 1002 may also include one or more communication interfaces 1047 for communicating with other electronic devices. The communication interfaces 1047 may be based on wired communication technology, wireless communication technology, or both. Examples of different types of communication interfaces 1047 include a serial port, a parallel port, a Universal Serial Bus (USB), an Ethernet adapter, an Institute of Electrical and Electronics Engineers (IEEE) 1394 bus interface, a small computer system interface (SCSI) bus interface, an infrared (IR) communication port, a Bluetooth wireless communication adapter, a 3rd Generation Partnership Project (3GPP) transceiver, an IEEE 802.11 (“Wi-Fi”) transceiver and so forth. For example, the communication interface 1047 may be coupled to one or more antennas (not shown) for transmitting and receiving wireless signals.

The electronic device 1002 may also include one or more input devices 1049 and one or more output devices 1053. Examples of different kinds of input devices 1049 include a keyboard, mouse, microphone, remote control device, button, joystick, trackball, touchpad, lightpen, etc. For instance, the electronic device 1002 may include one or more microphones 1051 for capturing acoustic signals. In one configuration, a microphone 1051 may be a transducer that converts acoustic signals (e.g., voice, speech) into electrical or electronic signals. Examples of different kinds of output devices 1053 include a speaker, printer, etc. For instance, the electronic device 1002 may include one or more speakers 1055. In one configuration, a speaker 1055 may be a transducer that converts electrical or electronic signals into acoustic signals. One specific type of output device which may be typically included in an electronic device 1002 is a display device 1057. Display devices 1057 used with configurations disclosed herein may utilize any suitable image projection technology, such as a cathode ray tube (CRT), liquid crystal display (LCD), light-emitting diode (LED), gas plasma, electroluminescence, or the like. A display controller 1059 may also be provided, for converting data stored in the memory 1061 into text, graphics, and/or moving images (as appropriate) shown on the display device 1057.

The various components of the electronic device 1002 may be coupled together by one or more buses, which may include a power bus, a control signal bus, a status signal bus, a data bus, etc. For simplicity, the various buses are illustrated in FIG. 10 as a bus system 1045. It should be noted that FIG. 10 illustrates only one possible configuration of an electronic device 1002. Various other architectures and components may be utilized.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

It should be noted that one or more of the features, functions, procedures, components, elements, structures, etc., described in connection with any one of the configurations described herein may be combined with one or more of the functions, procedures, components, elements, structures, etc., described in connection with any of the other configurations described herein, where compatible. In other words, any compatible combination of the functions, procedures, components, elements, etc., described herein may be implemented in accordance with the systems and methods disclosed herein.

The functions described herein may be stored as one or more instructions on a processor-readable or computer-readable medium. The term “computer-readable medium” refers to any available medium that can be accessed by a computer or processor. By way of example, and not limitation, such a medium may comprise Random-Access Memory (RAM), Read-Only Memory (ROM), Electrically Erasable Programmable Read-Only Memory (EEPROM), flash memory, Compact Disc Read-Only Memory (CD-ROM) or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-Ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for noise characteristic dependent speech enhancement by an electronic device, comprising:
determining a noise characteristic of input audio, comprising determining whether noise is stationary noise and determining whether the noise is music noise;
determining a noise reference based on the noise characteristic, comprising excluding a spatial noise reference from the noise reference when the noise is stationary noise and including the spatial noise reference in the noise reference when the noise is not music noise and is not stationary noise; and
performing noise suppression based on the noise characteristic.

2. The method of claim 1, wherein determining the noise reference further comprises including the spatial noise reference and including a music noise reference in the noise reference when the noise is music noise and is not stationary noise.

3. The method of claim 1, wherein determining the noise characteristic comprises detecting rhythmic noise, sustained polyphonic noise or both.

4. The method of claim 3, wherein detecting rhythmic noise comprises determining an onset of a beat based on a spectrogram and providing spectral features, and wherein determining the noise reference comprises determining a rhythmic noise reference when the beat is detected regularly.

5. The method of claim 3, wherein detecting sustained polyphonic noise comprises mapping a spectrogram to a group of subbands with center frequencies that are logarithmically scaled, detecting stationarity based on an energy ratio between a high-pass filter output and input for each subband and tracking stationarity for each subband, and wherein determining the noise reference comprises determining a sustained polyphonic noise reference based on the tracking.

6. The method of claim 1, wherein the spatial noise reference is determined based on directionality of the input audio.

7. The method of claim 1, wherein the spatial noise reference is determined based on a level offset.

8. An electronic device for noise characteristic dependent speech enhancement, comprising:
noise characteristic determiner circuitry that determines a noise characteristic of input audio, wherein determining the noise characteristic comprises determining whether noise is stationary noise and determining whether the noise is music noise;
noise reference determiner circuitry coupled to the noise characteristic determiner circuitry, wherein the noise reference determiner circuitry determines a noise reference based on the noise characteristic, wherein determining the noise reference comprises excluding a spatial noise reference from the noise reference when the noise is stationary noise and including the spatial noise reference in the noise reference when the noise is not music noise and is not stationary noise; and
noise suppressor circuitry coupled to the noise characteristic determiner circuitry and to the noise reference determiner circuitry, wherein the noise suppressor circuitry performs noise suppression based on the noise characteristic.

9. The electronic device of claim 8, wherein determining the noise reference further comprises including the spatial noise reference and including a music noise reference in the noise reference when the noise is music noise and is not stationary noise.

10. The electronic device of claim 8, wherein determining the noise characteristic comprises detecting rhythmic noise, sustained polyphonic noise or both.

11. The electronic device of claim 10, wherein detecting rhythmic noise comprises determining an onset of a beat based on a spectrogram and providing spectral features, and wherein determining the noise reference comprises determining a rhythmic noise reference when the beat is detected regularly.

12. The electronic device of claim 10, wherein detecting sustained polyphonic noise comprises mapping a spectrogram to a group of subbands with center frequencies that are logarithmically scaled, detecting stationarity based on an energy ratio between a high-pass filter output and input for each subband and tracking stationarity for each subband, and wherein determining the noise reference comprises determining a sustained polyphonic noise reference based on the tracking.

13. The electronic device of claim 8, wherein the spatial noise reference is determined based on directionality of the input audio.

14. The electronic device of claim 8, wherein the spatial noise reference is determined based on a level offset.

15. A computer-program product for noise characteristic dependent speech enhancement, comprising a non-transitory tangible computer-readable medium having instructions thereon, the instructions comprising:
code for causing an electronic device to determine a noise characteristic of input audio, comprising determining whether noise is stationary noise and determining whether the noise is music noise;
code for causing the electronic device to determine a noise reference based on the noise characteristic, comprising excluding a spatial noise reference from the noise reference when the noise is stationary noise and including the spatial noise reference in the noise reference when the noise is not music noise and is not stationary noise; and
code for causing the electronic device to perform noise suppression based on the noise characteristic.

16. The computer-program product of claim 15, wherein determining the noise reference further comprises including the spatial noise reference and including a music noise reference in the noise reference when the noise is music noise and is not stationary noise.

17. The computer-program product of claim 15, wherein determining the noise characteristic comprises detecting rhythmic noise, sustained polyphonic noise or both.

18. The computer-program product of claim 17, wherein detecting rhythmic noise comprises determining an onset of a beat based on a spectrogram and providing spectral features, and wherein determining the noise reference comprises determining a rhythmic noise reference when the beat is detected regularly.

19. The computer-program product of claim 17, wherein detecting sustained polyphonic noise comprises mapping a spectrogram to a group of subbands with center frequencies that are logarithmically scaled, detecting stationarity based on an energy ratio between a high-pass filter output and input for each subband and tracking stationarity for each subband, and wherein determining the noise reference comprises determining a sustained polyphonic noise reference based on the tracking.

20. The computer-program product of claim 15, wherein the spatial noise reference is determined based on directionality of the input audio.

21. The computer-program product of claim 15, wherein the spatial noise reference is determined based on a level offset.

22. An apparatus for noise characteristic dependent speech enhancement by an electronic device, comprising:
means for determining a noise characteristic of input audio, comprising means for determining whether noise is stationary noise and means for determining whether the noise is music noise;
means for determining a noise reference based on the noise characteristic, comprising excluding a spatial noise reference from the noise reference when the noise is stationary noise and including the spatial noise reference in the noise reference when the noise is not music noise and is not stationary noise; and
means for performing noise suppression based on the noise characteristic.

23. The apparatus of claim 22, wherein determining the noise reference further comprises including the spatial noise reference and including a music noise reference in the noise reference when the noise is music noise and is not stationary noise.

24. The apparatus of claim 22, wherein the means for determining the noise characteristic comprises means for detecting rhythmic noise, sustained polyphonic noise or both.

25. The apparatus of claim 24, wherein the means for detecting rhythmic noise comprises means for determining an onset of a beat based on a spectrogram and providing spectral features, and wherein the means for determining the noise reference comprises means for determining a rhythmic noise reference when the beat is detected regularly.

26. The apparatus of claim 24, wherein the means for detecting sustained polyphonic noise comprises means for mapping a spectrogram to a group of subbands with center frequencies that are logarithmically scaled, detecting stationarity based on an energy ratio between a high-pass filter output and input for each subband and tracking stationarity for each subband, and wherein the means for determining the noise reference comprises means for determining a sustained polyphonic noise reference based on the tracking.

27. The apparatus of claim 22, wherein the spatial noise reference is determined based on directionality of the input audio.

28. The apparatus of claim 22, wherein the spatial noise reference is determined based on a level offset.
